(19) United States
(12) Patent Application Publication
(10) Pub. No.: US 2016/0105037 A1
(43) Pub. Date: Apr. 14, 2016

(54) MULTIPLEX TRANSMISSION SYSTEM FOR WIRELESSLY TRANSMITTING POWER, TRANSMITTING SIDE MULTIPLEX TRANSMISSION DEVICE AND BILLING/INFORMATION SYSTEM

(71) Applicant: MITSUBISHI ELECTRIC ENGINEERING COMPANY, LIMITED, Tokyo (JP)

(72) Inventors: Yoshiyuki AKUZAWA, Chiyoda-ku (JP); Yoshiyuki TAKAHASHI, Chiyoda-ku (JP)

(73) Assignee: Mitsubishi Electric Engineering Corporation, Limited, Chiyoda-ku, Tokyo (JP)

(21) Appl. No.: 14/893,285

(22) PCT Filed: Oct. 17, 2013
(86) PCT No.: PCT/JP2013/078184

§ 371 Date: Nov. 23, 2015

(30) Foreign Application Priority Data
May 27, 2013 (JP) 2013-110805

(51) Int. Cl. H02J 5/00; H02J 17/00

(52) U.S. Cl. CPC H02J 5/005; H02J 17/00

(57) ABSTRACT

A multiplex transmission system including: a primary transmission power source that feeds power of a single frequency; a transmitter-receiver system that includes plural-line transmission antennas wirelessly transmitting power from the primary transmission power source, and plural-line reception antennas receiving power from the transmission antennas that form pairs with the reception antennas; a directional coupler-type transmission power source circuit establishing resonant condition of each of the transmission antennas; and plural-line reception power source circuits establishing resonant condition of each of the reception antennas that form the pairs. The directional coupler-type transmission power source circuit includes a directional coupler-type output filter that distributes power to the respective transmission antennas.

### TECHNICAL FIELD

The present invention relates to a multiplex transmission system by way of wireless power transmission, a transmitting side multiplex transmission device and a billing/information system, in which power is multiplexed and then transmitted in a contactless manner.

### BACKGROUND ART

Heretofore, in wireless power transmission devices, there has been known such a configuration that makes it possible to transmit power while boosting its voltage, because of provision of a plurality of power transmission units that cause transmission with a phase difference between their resonant magnetic fields so that they are shifted to each other in a range of 90 degrees or more but 180 degrees or less (see, for example, Patent Document 1).

### CITATION LIST

### Patent Document

Patent Document 1: International Publication Number WO2012/046453

### SUMMARY OF THE INVENTION

### Problems to be Solved by the Invention

However, according to the device of Patent Document 1, its purpose is to boost the voltage, and no consideration is taken to a problem due to multiplex transmission. Namely, according to this device, since a common magnetic field is produced between antennas of the respective lines, there is a problem that a mutual interference is induced between the plural antennas. Further, as the phase difference between resonant magnetic fields becomes near 180 degrees, they are mutually offset due to inversion in magnetic-flux direction between the antennas, so that there is also a problem that the transmission allowable amount of the energy decreases.

Accordingly, when multiplex transmission is to be performed with the conventional device, it is difficult to make the antennas of the respective lines closer in distance therebetween. In this respect, in order to reduce the influence of the mutual interference between the antennas, it is necessary to place the respective lines away from each other by the transmissible distance or more, or to apply a measure of magnetic shielding for separating the fluxes of the respective lines. Thus, there are problems that it is unable to reduce in size as a wireless power transmission system, and that it takes a cost for the measure of magnetic shielding and the like.

This invention has been made to solve the problems as described above, and an object thereof is to provide a multiplex transmission system by way of wireless power transmission, a transmitting side multiplex transmission device and a billing/information system, that can multiplex and then transmit power in a contactless manner with small-size and low-cost configurations.

### Means for Solving the Problems

The multiplex transmission system by way of wireless power transmission according to the invention comprises: a primary transmission power source that feeds power of a single frequency; a transmitter-receiver system that comprises plural-line transmission antennas for wirelessly transmitting the power from the primary transmission power source, and plural-line reception antennas for receiving power from the transmission antennas that form pairs with the reception antennas; a transmission power source circuit for establishing resonant condition of each of the transmission antennas; and plural-line reception power source circuits for establishing resonant condition of each of the reception antennas that form the pairs; wherein the transmission power source circuit is provided with a directional coupler-type output filter that distributes power to the respective transmission antennas.

Further, the billing/information system according to the invention is a billing/information system using the multiplex transmission system by way of wireless power transmission, wherein the transmission antennas are located in a plurality of power feedable areas, respectively; said billing/information system comprising: a billing/information receiver that acquires a billing or information equivalent to that billing, from an apparatus located in the power feedable area and provided with the reception antenna and the reception power source circuit; and a power feed controller that, according to the billing or the information acquired by the billing/information receiver, controls the primary transmission power source, the transmission power source circuit and the corresponding transmission antenna, so as to perform power feeding to the apparatus concerned.

### EFFECT OF THE INVENTION

According to the invention, because of the above-described configuration, it becomes possible to achieve a highly-efficient multiplex power transmission using a single fixed transmission frequency. Thus, such a design that satisfies the regulations in the Radio Act can be made easily. As a result, it becomes possible to achieve power increase in transmission power and to simplify the structure for magnetic shielding, so that low-cost commercial products without requiring a complex design can be accomplished. Further, since it becomes possible to avoid the problem of the mutual interference due to that the respective lines are made closer in antenna distance therebetween, the system can be reduced in size.

### BRIEF DESCRIPTION OF THE DRAWINGS

FIG. 1 is a diagram showing a configuration of a multiplex transmission system by way of wireless power transmission according to Embodiment 1 of the present invention.

FIG. 2 is a circuit diagram showing a configuration example of a directional coupler-type transmission power source circuit according to Embodiment 1 of the invention.

FIG. 3 is a diagram showing a configuration example of a conventional transmission power source circuit.

FIG. 4 is a diagram showing a configuration of a multiplex transmission system by way of wireless power transmission according to Embodiment 2 of the invention.

FIG. 5 is a diagram showing a configuration of a billing/information system according to Embodiment 3 of the invention.

FIG. 6 is a diagram showing another configuration of a billing/information system according to Embodiment 3 of the invention.

### MODES FOR CARRYING OUT THE INVENTION

Hereinafter, embodiments of the invention will be described in detail referring to the drawings.

### Embodiment 1

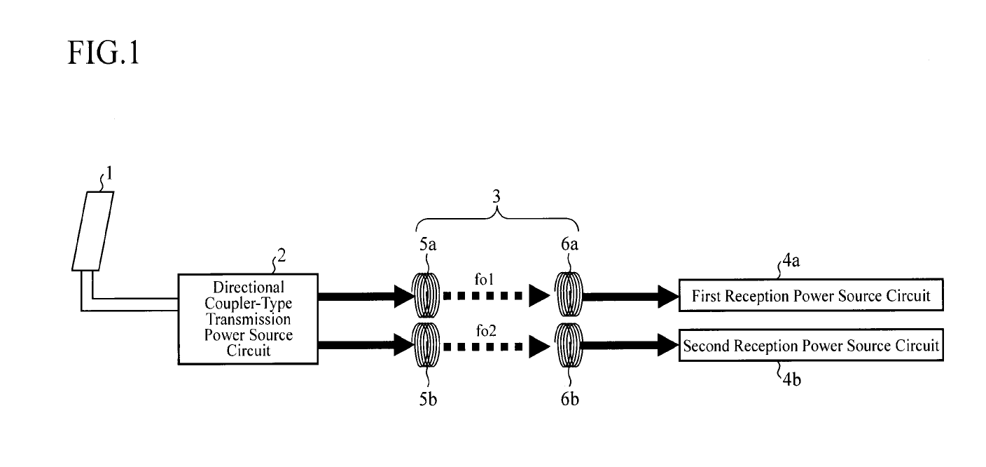

FIG. 1 is a diagram showing a configuration of a multiplex transmission system by way of wireless power transmission according to Embodiment 1 of the invention.

The multiplex transmission system by way of wireless power transmission is a system in which electric-signal containing powers in multiple lines are wirelessly transmitted in parallel. This multiplex transmission system by way of wireless power transmission is configured, as shown in FIG. 1, with a primary transmission power source 1, a directional coupler-type transmission power source circuit (transmission power source circuit) 2, a transmitter-receiver system 3 and reception power source circuits 4. Further, the transmitter-receiver system 3 has transmission antennas 5 and reception antennas 6. In order to perform multiplex transmission, the multiplex transmission system has the transmission antennas 5, the reception antennas 6 and the reception power source circuits 4, respectively in a plural-line form (shown in the example in FIG. 1 is a case of forming them respectively in a two-line form, so that suffixed symbols a, b are given to the numerals of the respective functional parts). In the multiplex transmission system shown in FIG. 1, the primary transmission power source 1, the directional coupler-type transmission power source circuit 2, and the transmission antennas 5 constitute a transmitting side multiplex transmission device, while the reception antennas 6 and the reception power source circuits 4 constitute receiving side multiplex transmission devices.

The primary transmission power source 1 serves to feed power of a single frequency to the respective transmission antennas 5 through the directional coupler-type transmission power source circuit 2.

The directional coupler-type transmission power source circuit 2 is placed between the primary transmission power source 1 and the transmission antennas 5, and serves to establish resonant condition of each of the transmission antennas 5 by resonant impedance control. On this occasion, the transmission power source circuit performs synchronization to a resonant frequency, as well as performs distribution of power to the respective transmission antennas 5. Details of this directional coupler-type transmission power source circuit 2 will be described later.

The transmission antennas 5 serve to wirelessly transmit to the reception antennas 6, the power fed through the directional coupler-type transmission power source circuit 2 from the primary transmission power source 1.

The reception antennas 6 serve to receive the power from the transmission antennas 5 that form pairs with the reception antennas. The power received by the reception antennas 6 is supplied to loading apparatuses or the like (not shown) through the reception power source circuits 4.

The reception power source circuits 4 are placed between the reception antennas 6 and the loading apparatuses or the like, and serve to establish resonant condition of each of the reception antennas 6 that form the pairs, by input impedance control . On this occasion, the reception power source circuits performs synchronization of the resonant frequencies (fo1=fo2, shown in FIG. 1).

It should be noted that a wirelessly transmitting method by the transmitter-receiver system 3 is not specifically limited, and maybe anyone of a method using magnetic field resonance, a method using electric field resonance and a method using electromagnetic resonance.

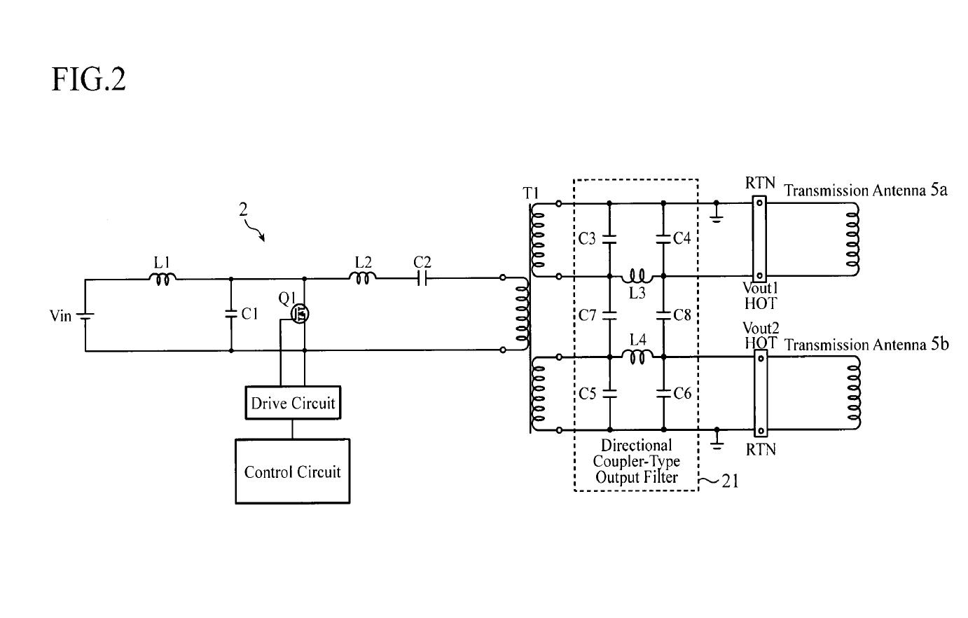

Next, the configuration of the directional coupler-type transmission power source circuit 2 will be described. FIG. 2 is a circuit diagram showing a configuration example of the directional coupler-type transmission power source circuit 2 according to Embodiment 1 of the invention.

In the directional coupler-type transmission power source circuit 2, as shown in FIG. 2, output lines for the respective transmission antennas 5 are connected to the secondary side of a transformer T1. Further, a directional coupler-type output filter is provided astride the respective output lines. This directional coupler-type output filter 21 serves to distribute power to the respective transmission antennas 5. As shown in FIG. 2, the directional coupler-type output filter 21 is constituted, for example, by capacitors C3 to C8 and coils L3 and L4.

Next, the operation of the directional coupler-type transmission power source circuit 2 will be described referring to FIG. 2.

In the operation of the directional coupler-type transmission power source circuit 2, firstly, according to the switching operation of a switching element Q1, an AC voltage is produced in each of the windings of the transformer T1.

Then, the AC voltage transferred from the secondary-side output winding of the transformer T1 to the capacitor C3, is transmitted to the transmission antenna 5a and the transmission antenna 5b respectively through the following sets of two routes.
(1-1) Capacitor C3→Coil L3→Capacitor C4→Transmission Antenna 5a
(1-2) Capacitor C3→Capacitor C7→Coil L4→Capacitor C8→Capacitor C4→Transmission Antenna 5a
(2-1) Capacitor C3→Coil L3→Capacitor C8→Capacitor C6→Transmission Antenna 5b
(2-2) Capacitor C3→Capacitor C7→Coil L4→Capacitor C6→Transmission Antenna 5b

Here, the AC voltages transmitted to the respective transmission antennas 5a, 5b have a characteristic that their amplitude are almost the same but their phases are different by 90 degrees. By utilizing this characteristic, in a pass characteristic toward the reception antenna 6a through the following two routes, it becomes possible to get opposite phases with almost the same amplitude.
(1) Capacitor C3→Transmission Antenna 5a→Reception Antenna 6a
(2) Capacitor C3→Transmission Antenna 5b→Reception Antenna 6a

Further, a pass characteristic from the capacitor C5 toward the reception antenna 6b can be such a characteristic similar to the above. Consequently, it is possible to accomplish dual wireless power transmissions independent of each other.

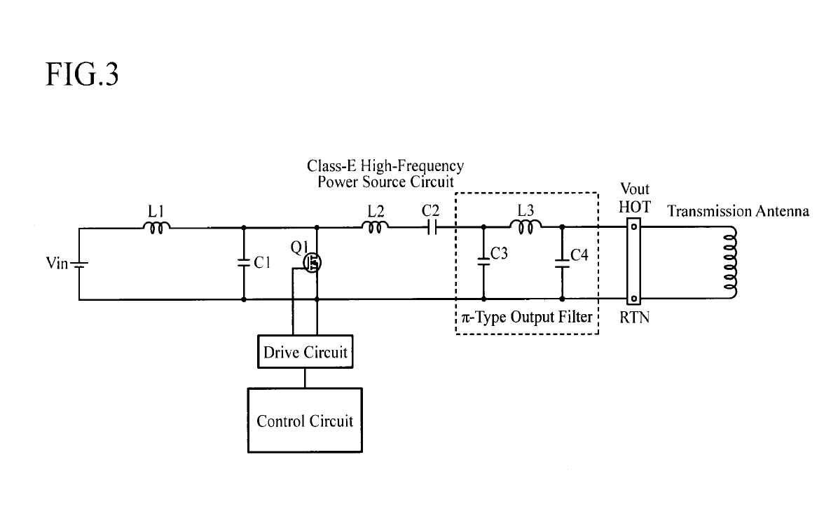

Note that the directional coupler-type output filter 21 as shown in FIG. 2 can be fabricated easily by utilizing a n-type output filter that is provided in the conventional transmission power source circuit shown in FIG. 3 for correcting distortion in its output voltage. Further, the directional coupler-type output filter 21 is not limited to have the configuration shown in FIG. 2, and may have any configuration that can distribute power without mutual interference between the respective lines.

As describe above, according to Embodiment 1, it is so configured that power is distributed to the respective transmission antennas 5 using the directional coupler-type transmission power source circuit 2, so that it becomes possible to achieve a highly-efficient multiplex power transmission using a single fixed transmission frequency. Thus, by use of an ISM band or the like, such a design that satisfies the regulations in the Radio Act can be made easily. As a result, it becomes possible to achieve power increase in transmission power and to simplify the structure for magnetic shielding, so that low-cost commercial products without requiring a complex design can be accomplished. Further, since it becomes possible to avoid the problem of the mutual interference due to that the respective lines are made closer in antenna distance therebetween, the system can be reduced in size. Furthermore, even when a plural number of single-line wireless power transmission devices are placed at a short distance from each other, when a phase control in voltage and current between their respective transmission power sources is performed similarly to the above, it is possible to avoid the problem of the mutual interference between the respective lines.

### Embodiment 2

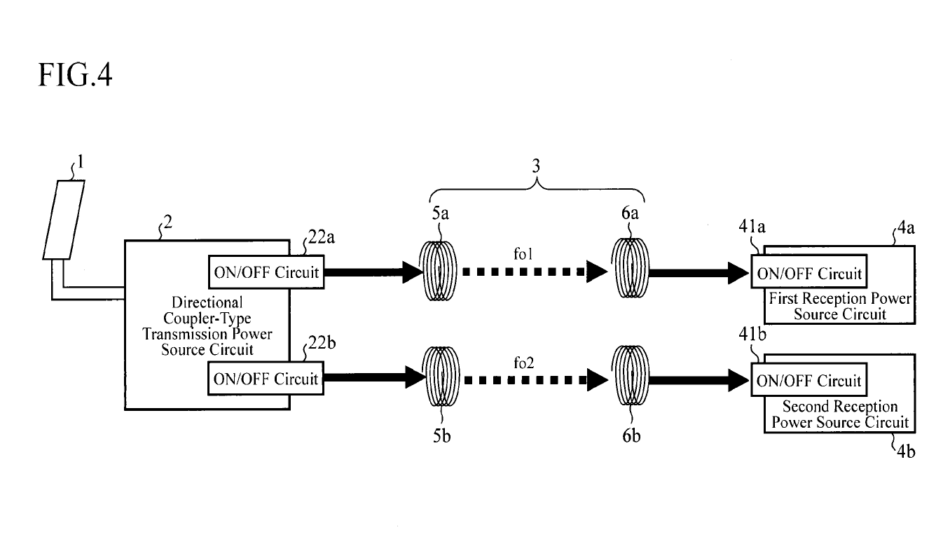

FIG. 4 is a diagram showing a configuration of a multiplex transmission system by way of wireless power transmission according to Embodiment 2 of the invention. The multiplex transmission system by way of wireless power transmission according to Embodiment 2 shown in FIG. 4, corresponds to the multiplex transmission system by way of wireless power transmission according to Embodiment 1 shown in FIG. 1, except that ON/OFF circuits 22, 41 are added in the directional coupler-type transmission power source circuit 2 and the reception power source circuits 4, respectively. Their configurations other than the above are similar to each other, so that description will be made only about the different part.

The ON/OFF circuits 22 can arbitrarily set ON/OFF of the operation of the directional coupler-type transmission power source circuit 2 for each of the transmission antennas 5.

The ON/OFF circuits 41 can arbitrarily set ON/OFF of the operations of the reception power source circuits 4.

As described above, according to Embodiment 2, in the directional coupler-type transmission power source circuit 2 and the reception power source circuits 4, there are provided the ON/OFF circuits 22, 41 capable of setting ON/OFF of the operation for each transmission line/reception line. Thus, it is possible to operate only the necessary transmission line/reception line.

Note that in FIG. 4, such a case has been shown where the ON/OFF circuits 22, 41 are provided in both of the directional coupler-type transmission power source circuit 2 and the reception power source circuit 4; however, the circuits may be provided in either one of them.

Further, in Embodiments 1 and 2, such cases have been shown where the transmission antennas 5 and the reception antennas 6 are each configured by a single coil. However, this is not limitative, and each of the respective coils may instead be configured, for example, by a power-feeding coil and a resonant coil, or may instead be configured by two or more coils.

Meanwhile, at each reception antenna 6, the resonant condition varies due to the distance between it and the transmission antenna 5 that forms a pair with it, and due to a load current/load impedance, etc. For that reason, in the reception-side circuit 4, such a function may be added that can change the resonant condition to be established for the reception antenna 6, according to a change in such transmission conditions. Likewise, in the directional coupler-type transmission power source circuit 2, such a function may be added that can change the resonant condition of the transmission antenna 5. Furthermore, in both of the circuits 2 and 4, such functions may be added that can change the resonant conditions of the respective antennas 5 and 6.

### Embodiment 3

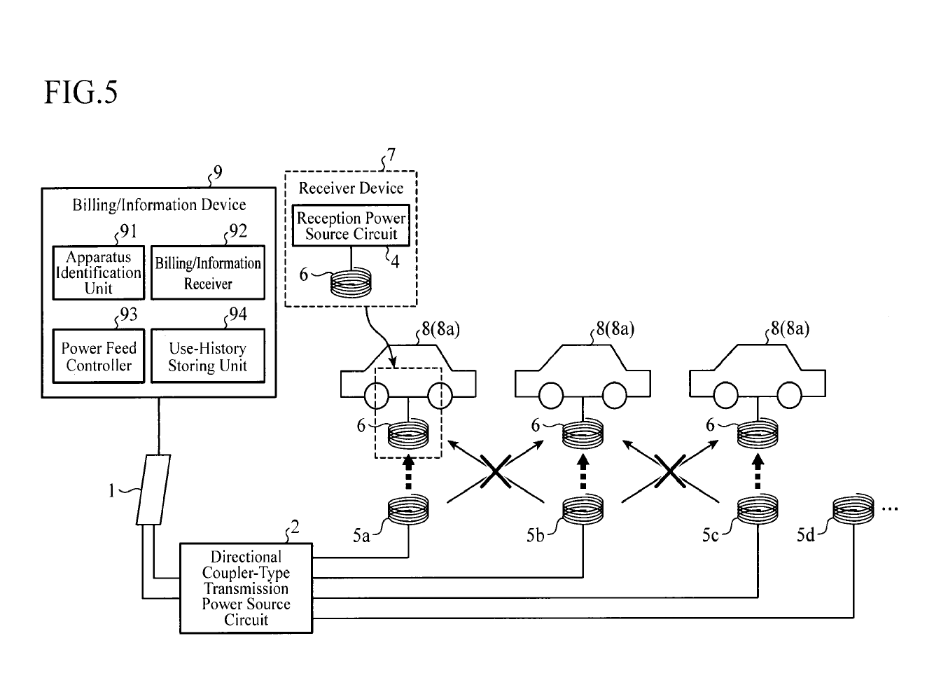

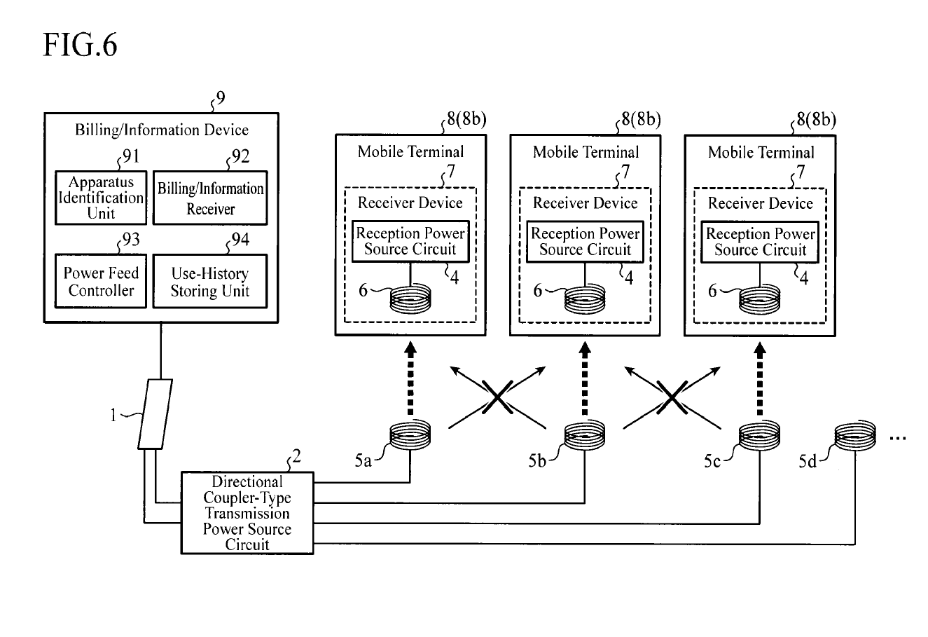

In Embodiment 3, a case will be shown where the multiplex transmission system by way of wireless power transmission according to Embodiment 1 shown in FIG. 1, is applied to a billing/information system. FIGS. 5 and 6 are diagrams each showing a configuration of the billing/information system according to Embodiment 3 of the invention.

The billing/information system serves to acquire a billing or information equivalent to that billing from each apparatus 8 each located in a power feedable area and provided with a receiver device 7, to thereby perform power feeding in response to that acquisition. The billing/information system is configured, as shown in FIGS. 5, 6, with a billing/information device 9 and the multiplex system by way of wireless power transmission according to Embodiment 1. Here, the reception antenna 6 and the reception power source circuit 4 in the multiplex system by way of wireless power transmission are provided as the receiver device 7 in the apparatus 8. Note that, in FIG. 5, a case is shown where the apparatus 8 is a moving object (for example, an electric motorcar, an electric motorcycle, an electric bicycle, an electric golf cart, or an electric wheelchair) 8a, and in FIG. 6, a case is shown where the apparatus 8 is a mobile terminal (for example, a smartphone, a tablet PC, a notebook PC, a mobile power-feeding booster) 8b. Further, the transmission antennas 5 are located in a plurality of power feedable areas, respectively.

The billing/information device 9 is configured, as shown in FIGS. 5 and 6, with an apparatus identification unit 91, a billing/information receiver 92, a power feed controller 93 and a use-history storing unit 94.

The apparatus identification unit 91 serves to identify the apparatus 8 located in the power feedable area and provided with the receiver device 7.

The billing/information receiver 92 serves to acquire from the apparatus 8 identified by the apparatus identification unit 91, a billing or information equivalent to that billing (for example, information related to a credit card transaction, an ETC transaction or a smartphone transaction).

The power feed controller 93 serves to control, according to the billing or the information acquired by the billing/information receiver 92, the primary transmission power source 1, the transmission power source circuit 2 and the corresponding transmission antenna 5, so as to perform power feeding to the apparatus 8 concerned. On this occasion, the use of the multiplex transmission system by way of wireless power transmission of the invention makes it possible to prevent the mutual interference from occurring between the adjacent power feedable areas, thus allowing power transmissions independent of each other.

The use-history storing unit 94 serves to store a history related to power feeding by the power feed controller 93, for every apparatus 8 identified by the apparatus identification unit 91.

As described above, according to Embodiment 3, because the multiplex transmission system by way of wireless power transmission of the invention is applied to a billing/information system, it is possible to prevent the mutual interference from occurring between the adjacent power feedable areas at the time of performing power feeding, thus allowing power transmissions independent of each other.

It should be noted that unlimited combination of the respective embodiments, modification of any configuration element in the embodiments and omission of any configuration element in the embodiments may be made in the present invention without departing from the scope of the invention.

### INDSUTRIAL APPLICABILITY

The multiplex transmission system by way of wireless power transmission according to the invention can multiplex and then transmit power in a contactless manner with small-size and low-cost configuration, and is thus suited to be used as a multiplex transmission system by way of wireless power transmission, or the like, in which power is multiplexed and then transmitted in a contactless manner.

### DESCRIPTION OF REFERENCE NUMERALS and SIGNS

1: primary transmission power source,
2: directional coupler-type transmission power source circuit,
3: transmitter-receiver system,
4, 4a, 4b: reception power source circuits,
5, 5a, 5b: transmission antennas,
6, 6a, 6b: reception antennas,
7: receiver device,
8: apparatus,
8a: moving object,
8b: mobile terminal,
9: billing/information device,
21: directional coupler-type output filter,
22, 22a, 22b, 41, 41a, 41b: ON/OFF circuits,
91: apparatus identification unit,
92: billing/information receiver,
93: power feed controller,
94: use-history storing unit.

1. A multiplex transmission system by way of wireless power transmission, comprising:
a primary transmission power source that feeds power of a single frequency;
a transmitter-receiver system that comprises plural-line transmission antennas for wirelessly transmitting the power from the primary transmission power source, and plural-line reception antennas for receiving power from the transmission antennas that form pairs with the reception antennas;
a transmission power source circuit for establishing resonant condition of each of the transmission antennas; and
plural-line reception power source circuits for establishing resonant condition of each of the reception antennas that form the pairs;
wherein the transmission power source circuit is provided with a directional coupler-type output filter that distributes power to the respective transmission antennas.

2. The multiplex transmission system by way of wireless power transmission of claim 1, wherein the transmitter-receiver system performs wireless transmission by using magnetic field resonance.

3. The multiplex transmission system by way of wireless power transmission of claim 1, wherein the transmitter-receiver system performs wireless transmission by using electric field resonance.

4. The multiplex transmission system by way of wireless power transmission of claim 1, wherein the transmitter-receiver system performs wireless transmission by using electromagnetic induction.

5. The multiplex transmission system by way of wireless power transmission of claim 1, wherein the transmission antennas and the reception antennas are each constituted by two or more coils.

6. The multiplex transmission system by way of wireless power transmission of claim 1, wherein the reception power source circuit can change the resonance condition of the reception antennas according to a transmission condition by that reception antenna.

7. The multiplex transmission system by way of wireless power transmission of claim 1, wherein the transmission power source circuit can change the resonance condition of the transmission antenna according to a transmission condition by that transmission antenna.

8. The multiplex transmission system by way of wireless power transmission of claim 1, wherein the reception power source circuit has, with respect to its own operation, an ON/OFF circuit capable of setting ON/OFF of that operation.

9. The multiplex transmission system by way of wireless power transmission of claim 1, wherein the transmission power source circuit has, with respect to its own operation for each of the transmission antennas, ON/OFF circuits each capable of setting ON/OFF of that operation.

10. A transmitting side multiplex transmission device, comprising:
a primary transmission power source that feeds power of a single frequency;
plural-line transmission antennas for wirelessly transmitting the power from the primary transmission power source; and
a transmission power source circuit for establishing resonant condition of each of the transmission antennas;
wherein the transmission power source circuit is provided with a directional coupler-type output filter that distributes power to the respective transmission antennas.

11. A billing/information system using the multiplex transmission system by way of wireless power transmission of claim 1, wherein the transmission antennas are located in a plurality of power feedable areas, respectively;
said billing/information system comprising:
a billing/information receiver that acquires a billing or information equivalent to that billing, from an apparatus located in the power feedable area and provided with the reception antenna and the reception power source circuit; and
a power feed controller that, according to the billing or the information acquired by the billing/information receiver, controls the primary transmission power source, the transmission power source circuit and the corresponding transmission antenna, so as to perform power feeding to the apparatus concerned.
